(19) United States
(12) Patent Application Publication
(10) Pub. No.: US 2003/0225690 A1
(43) Pub. Date: Dec. 4, 2003

(54) Billing process and system

(75) Inventor: Richard B. Eaton, Rochester, NY (US)

Correspondence Address: Patent Documentation Center, Xerox Corporation, Xerox Sq. 20th Floor, 100 Clinton Avenue South, Rochester, NY, 14644, US

(73) Assignee: Xerox Corporation

(21) Appl. No.: 10/158,474

(22) Filed: May 29, 2002

(51) Int. Cl. G06F 17/60

(52) U.S. Cl. 705/40

(57) ABSTRACT

A billing process and system for enabling expedited and simplified resolution of line items between a biller and a billee. The billing process and system allows for communicating electronically a bill; receiving an electronic communication of at least one discrepancy in the insurance bill; communicating electronically a proposed modification to the insurance bill corresponding to the at least one discrepancy in the insurance bill; receiving electronic acceptance of the proposed modification; and electronic reconciliation in an accounts receivable record.

### FIELD OF THE INVENTION

The invention relates to billing processes and systems, and in particular to an improved dynamic billing system and process for electronic billing between a provider of products or services and a customer in which interactive electronic communication therebetween may lead to acceptance of proposed changes, authorization of payment to be made by a customer, and electronic integration and reconciliation of records to be efficiently updated providing an improved payment cycle.

### BACKGROUND OF THE INVENTION

Existing bill payment systems generally use a manual and time intensive bill correction process which is inefficient and costly to administer. These systems are often based on handling billing discrepancies as individual exceptions rather than programmatically using computer technology. For example, a customer after recognizing a billing problem may contest individual line items after first identifying and collecting all of the disputes associated with the bill and then provide such collected line items with correspondence along with a reduced payment back to the company for adjudication. In some situations, the disputed amount may be applied incorrectly. For example, a health insurance company may send a company a bill with line items associated with specific employees. Upon receipt, the company may contest employment of a named employee and send back a partial payment to the health insurance company due to the disputed employee. The dispute may be legitimate but the employee may not have been taken off the insurance or employment records. The company receiving a bill will generally err in the direction of what's in their favor and not make full payment until the dispute is settled which generally involves considerable efforts and time for the parties involved.

Moreover, situations where a partial payment is made are generally insufficient to satisfy the accounts receivable department. When the accounts receivable receives partial payment, they still expect the full payment originally billed to the customer because they are not always informed of the billing problem and adjustment. When they are later notified, accounts receivable must update accounts receivable retroactively in order to make the accounts balance which leads to considerable bookkeeping efforts.

While existing billing systems are generally suitable, improvements in billing efficiency and resolution of line item disputes between billers and billee are desired. Therefore, an improved dynamic billing process and system providing interactive would be beneficial.

Reference is made to billing systems in U.S. Pat. Nos. 6,044,362; 6,070,150; and 6,289,322.

All documents cited herein, including the foregoing, are incorporated herein by reference in their entireties.

### SUMMARY OF THE INVENTION

In embodiments, provided is a process and system for performing dynamic billing by a provider of services or products to a customer. Dynamic billing relates to an electronic billing process and system that interactively allows for billing disputes to be timely addressed and for changes and reconciliation and integration of the disputes to be proposed and accepted by two parties. For example, dynamic billing provides for situations in which the biller may get a payment different from that originally posted to their accounts receivable system but also gets the corresponding data to reconcile this difference in the accounts receivables records. The process may be manual or automatic. The billing may be for an industry specific user such as healthcare. Dynamic billing refers to billing that interactively allows for changes to be proposed and accepted by two parties such as a biller and billee, and where the biller gets a payment different from that originally posted to their accounts receivable records but also gets the corresponding data to integrate and reconcile any differences.

In accordance with an embodiment there is provided a billing process including: generating an electronic first bill, the electronic first bill including at least one line item; communicating electronically the first bill; receiving electronically an indication of a billing discrepancy including a request for reconsideration of the at least one line item of the first bill; reconsidering the at least one line item of the first bill; communicating electronically the request for reconsideration of the at least one line item of the first bill is at least one of accepted or denied; generating an electronic second bill including an adjustment of the at least one line item; communicating electronically the second bill; and integrating the adjustment of the at least one line item into an account record.

In accordance with another embodiment there is provided a billing system including a computer network and computer readable medium associated with the computer network, the computer readable medium is adapted for: (1) generation of a first bill having at least one line item totaling a first amount; (2) electronic storage of the first bill; (3) electronic communication of the first bill from a biller to a billee and to an account receivable record; (4) interactive electronic communication between the billee and the biller relating to a discrepancy in the first bill; and (5) electronic reconciliation in the accounts receivable record of a difference between the first amount of the first bill and a second amount of a second bill electronically sent by the biller to the billee.

In accordance with yet another embodiment there is provided an insurance billing process including: communicating electronically an insurance bill; receiving an electronic communication of at least one discrepancy in the insurance bill; communicating electronically a proposed modification to the insurance bill corresponding to the at least one discrepancy in the insurance bill; receiving electronic acceptance of the proposed modification; and electronic reconciliation in an accounts receivable record.

In accordance with yet another embodiment there is provided a process of billing including generating a first bill including at least one line item; storing the first bill in memory suitable for electronic presentment; communicating electronically the first bill; receiving electronically an indication of a billing discrepancy including a request for reconsideration of the at least one line item of the first bill; reconsidering the at least one line item of the first bill which was requested to be reconsidered as part of the indication of a billing discrepancy; communicating electronically that the request for reconsideration of the at least one line item of the first bill is at least one of accepted or denied; calculating at least one adjustment for each line item accepted in the request for reconsideration associating the at least one adjustment of the each line item accepted in reconsideration with the first bill in memory; generating a second bill including the at least one adjustment of the at least one line item; communicating electronically the second bill; receiving payment of the second bill associated with the at least one adjustments; and reconciling the at least one adjustment and payment in an account receivable record.

In accordance with another embodiment there is provided a computer system for interactive resolution of a line item of an electronic bill between a biller and a billee including a computer network; and computer readable medium associated with the computer network. The computer readable medium contains instructions for at least one electronic communication between a biller and a billee including at least one proposed adjustment to a line item of an electronic bill; and electronic tracking of the at least one proposed adjustment and the at least one electronic communication sufficient for an update of an account receivables record.

Still other aspects and advantages of the present invention and methods of construction of the same will become readily apparent to those skilled in the art from the following detailed description, wherein embodiments are shown and described, simply by way of illustration. As will be realized, the invention is capable of other and different embodiments and methods of construction, and its several details are capable of modification and interchangeability in various respects, all without departing from the invention. Accordingly, the drawing and description are to be regarded as illustrative in nature, and not as restrictive.

### BRIEF DESCRIPTION OF THE DRAWINGS

FIG.1 illustrates a diagram of a system for providing billing services in accordance with an embodiment;

FIG.2 is a diagram of a server used for billing services in accordance with an embodiment; and

FIG.3 is a flowchart illustrating a process for billing in accordance with an embodiment.

### DETAILED DESCRIPTION OF THE INVENTION

While the principles and embodiments described will generally be described in connection with the healthcare industry, it should be understood that the billing system and methods thereof are not limited to that embodiment or to that application. Therefore, it should be understood that the principles of the embodiments extend to all alternatives, modifications, and equivalents thereof. The systems and processes may be adapted for use in a variety of industries including aerospace, automotive, petroleum & chemical, communications, consumer products, pharmaceutical, technology, transportation, utilities, public sector, government, healthcare, insurance, graphic arts, education, life sciences, financial services, legal, retail, manufacturing, and industrial.

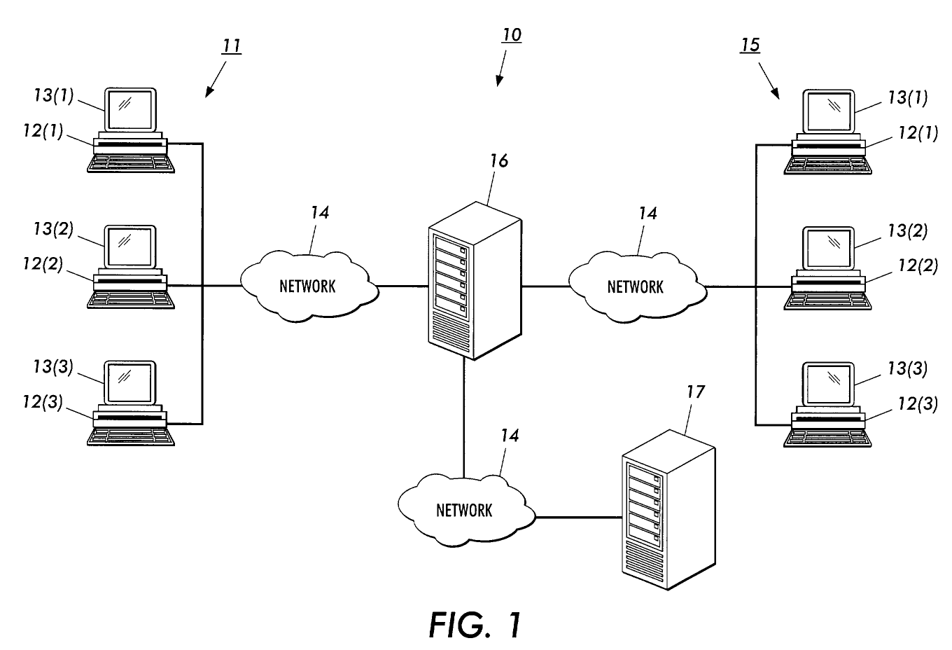

Reference is made to FIG. 1 illustrating in an embodiment, a biller 11 and billee 15 personal computers, 12(1)-12(n), comprising one or more processors (not illustrated), one or more memory storage devices (not illustrated) one or more input/output devices (not illustrated), including communication devices such as modems (not illustrated), a display device 13(1)-13(n), such as a conventional color or monochrome computer monitor, and one or more user input devices, such as a mouse, keyboard, light-pen and/or a track-ball (not illustrated). Since the components of a personal computer and their operation are well known, they will not be described in detail herein. Each of the personal computers 12(1)-12(n) may utilize one or more types of operating systems including, for example, Linux®, Windows®, Macintosh®, UNIX®, SunOS®, and equivalents thereof. Additionally, each of the personal computers 12(1)-12(n) may use conventionally known e-mail applications to generate, send, receive or display e-mail messages, including Microsoft Outlook®, Eudora® or AOL®, for example. Further, each of the personal computers 12(1)-12(n) may retrieve, load and display Web pages using conventionally known Web browsers such as Microsoft's Internet Explorer®, Netscape® or AOL®, for example. Although in this particular embodiment, personal computers 12(1)-12(n) are shown, other types of systems, such as a lap-top computer, work station, palm-top computer, Internet-ready/digital mobile telephone, dumb terminal or any other larger or smaller processing system, can be used.

In embodiments, the personal computers 12(1)-12(n) may be coupled to each other to form a local area network (“LAN”), such as an Ethernet®. In this example, the LAN would use one or more protocols, such as TCP/IP or Novell Netware®. Further in this example, one or more of personal computers 12(1)-12(n) would fulfill a server role and therefore provide the operative coupling to networks 14, and billing server 16. A variety of other types of networks may couple personal computers 12(1)-12(n) together, including a WAN or any other type of network. Networks such as intranet or Internet couple the project server 16 to personal computers 12(1)-12(n).

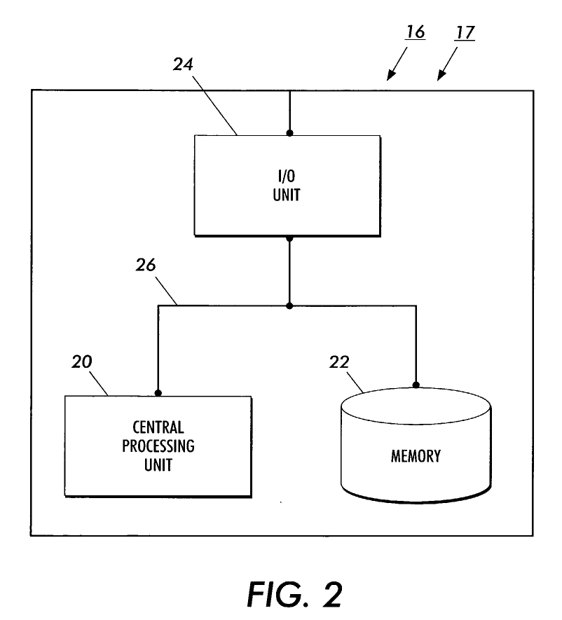

Referring to FIGS. 1 and 2, in embodiments billing server 16 comprises a central processing unit (“CPU”) 20, such as an Intel Pentium processor, memory 22 and I/O unit 24, which are coupled together by a bus 26. CPU 20 executes a program of stored instructions for a method for bill presentment in accordance with the present invention as described and illustrated herein. CPU 20 may also execute instructions for other tasks, including network services for providing data, memory, file directories, individual files, word processing applications, or accounting applications.

Memory 22 may comprise any type of memory device accessible by the CPU 20, such as ferroelectric memory, read only memory (“ROM”), random access memory (“RAM”), electrically erasable programmable read only memory (“EEPROM”), erasable programmable read only memory (“EPROM”), flash memory, static random access memory (“SRAM”), dynamic random access memory (“DRAM”), ferromagnetic memory, charge coupled devices, or any other type of computer-readable mediums. In embodiments, memory 22 may comprise a portable memory device (i.e., personal computers 12(1)-12(n)). Examples of such devices include floppy-disks, hard-disks, Zip® disks, Compact Disks (“CD”), Digital Video Disks (“DVD”), computer-readable cassette tapes or reels, magnetic tapes, optical disks, smart cards or computer-readable punch cards. Further, the programmed instructions for performing one or more methods are stored in memory 22 for execution by CPU 20. The instructions may be expressed as executable programs written in computer programming languages, such as BASIC, Pascal, C, C++, C#, Java, Perl, COBOL, FORTRAN, assembly language, machine code language or any computer code or language that may be understood and performed by the CPU 20.

Billing server 16 may communicate with personal computers 12(1)-12(n) through I/O unit 24. In addition, billing server 16 may communicate with another computer system such as a mainframe computer 17 having accounting software where accounts receivable accounting would be maintained and executed. Mainframe computer 17 may include a similar architecture as billing server 16. In an embodiment, I/O unit 24 may comprise a router such as any type of Ethernet® based device having sufficient ports to operatively couple billing server 16 to networks 14, and hence, personal computers 12(1)-12(n). Billing server 16 may comprise a Microsoft IIS® Web server, although other types of systems can be used such as a WebSphere®, Apache® or Netscape® server or other types of computer systems. Billing server 16 and mainframe computer 17 may also comprise any type of device with circuitry that is hard-wired to execute instructions for performing one or more functions as described further herein. Billing server 16 and mainframe computer 17 may execute instructions for one or more operating system environments it is operating in such as the UNIX® environment.

In an embodiment, dynamic billing may be used in the context of a healthcare insurance provider environment but it is not limited to the healthcare industry as it may be used in other industries including various industries and utilities.

In healthcare, internal records are often out of date and the process for adding people for coverage is clear, methodical and understood. Insurer extraction of the bill data from the billing information occurs so that the data may be presented electronically. Very often the insurer will required by regulation to actually print the bill as well, but they would also be able to extract that data for use in a repository for the electronic invoice. Once the data is in a repository, the biller and billee can look at the current bill. The bill data may also be converted to HTML. After a dispute of line items, it is incumbent on the biller to present a corrected bill to a billee. The biller can't rerun the billing process again because it's already been performed and the data base in the server or mainframe computer is altered and cannot easily be undone. The biller must keep track of the discrepancies and the discrepancies are used along with the original bill and a new corrected bill including adjustments is generated and sent to the billee. The bookkeeping must balance.

The system may include hardware and software to allow, for example, an insurance company to electronically provide a dynamic bill, rather than a static bill, whereby the customer can contest any portion of the bill and that contestment is programmatically fed back into an existing invoicing system whereby with internal approvals, and in an automated process, it electronically recreates a new electronic bill including any corrections. Then, once the bill is accepted by the customer and the customer agrees to pay that amount the new claim is sent to the accounts receivable department and the original bill is associated with the corresponding updated invoice sufficient to update the records. The system and process allows feedback to and from the biller that electronically confirms to a billee that they, for example, had purchased a selected product or service. Alternatively, the biller has an opportunity to electronically interact with the billee and to efficiently approve the customer's proposed correction, for example, if an error was involved in the bill.

This electronic feedback and interaction may occur between a biller and a billee such as in a supplier and customer relationship. For example, a customer may identify and question a particular line item of an electronic invoice and then send an electronic message to the biller, stating that this line item is incorrect and wishes it to be removed. In a health care environment, the invoice may be incorrect for a group or company because of an incorrect head count. The XYZ company may receive a healthcare bill for six employees, however, one of the company's employees may have left the previous week so the company wants the departed employee taken off this employee list so they approve employees one to five and disapprove the other employee. Then XYZ company electronically sends back that information to the health insurer which can electronically approve the change and have that person removed from the invoice as of a specified date. An individual may also be added to the invoice if XYZ company indicated an employee was missing. The health insurer then recalculates the bill and sends back an electronically corrected bill to the customer. The customer may approve this bill and pay it. The customer may click an icon or button which signifies their intent to pay or actual payment thereof and the funds may be transferred from their checking account or savings. Payment can be an electronic funds transfer or the company may send a check via mail or other service.

Communication between the biller and billee is performed using electronic and internet technologies. Over the Internet, the delays are seconds, not days. Communication may occur in nearly real time. Moreover, mailing disputed or corrected invoices back and forth using the postal service is unnecessary. A human mechanical process may be integrated or supplement the electronic process. Using a human intervention process may be performed in near real time. The insurer may is indicate to the company, via human or electronically, they have not filled out the necessary paperwork and the claim may be refused.

The dynamic billing process may start with the company creating a bill and then billing the customer. When the bill is created, it is generally because services have been rendered and the bill is posted to an accounts receivable department. Now, the company has money that somebody owes them and the bill is presented to the customer. Using a dynamic billing a corrected bill could be quickly received. Dynamic billing allows for a billee to quickly obtain a corrected bill that they are paying. It is not necessary for a billee to partially pay a bill and thereafter contest part of it. The biller and the billee can generally quickly resolve any conflict electronically or online and you have a corrected bill soon thereafter, perhaps within minutes of electronically communicating a dispute to a biller.

The interface between billers and billees, can be quite simple because the person receiving the bill sees the bills and sees the items that need to be paid and then has selectable choices. The billee can identify something that they wish to dispute and request another bill and then the once that happens, then the biller needs to approve any such changes. The biller would have a copy of the original bill, they would have the comment of the customer, they would have everything they need to answer the questions and resolve the issue. The communication between a biller and billee may use the technology of, for example, e-mail, an electronic data interchange (EDI) transaction, phone line, or an internal process, through an internet TCP/IP technology, and dedicated lines. Communication and resolution may be through a human or through an automated process. In an automated process, for example, each disputed line items may be identified and the billee is provided with a choice of, for example, a variety of selectable options, each describing a reason why they are not satisfied with the line item. For example, the product or service was not received, unsatisfactory product or service, person died, etc. Then, the billee could just merely click the particular one or more reasons or type in at a specified location other pertinent information and then it would be sent and it could be adjudicated automatically by the biller. The biller may select an allowed number of dispute cycles or select a time frame that a biller may be allowed to dispute the matter to be interactively adjudicated. Such limits could reduce the payment cycle.

### Example Embodiment of Insurer to Company Bill Process

Insurer posts amount to account receivable.

Insurer generates bill for Company.

Insurer extraction of bill data for Company.

Insurer storing of billing data of electronic invoice for Company.

Insurer presenting of electronic invoice to Company over Internet.

Company identifies discrepancy in billing and notifies health insurance company of discrepancy, for example, a new insuree.

Company makes internal request for change to Insurer records.

Insurer makes manual paper or electronic request for change to Insurers record.

Company makes manual or electronic editing change to records where adjustment is applied.

Insurer approves change to records, such as new insuree, and adds new insuree name and data to Company membership and database and calculates adjustment (credit or debit) to Company.

Insurer makes change to records using portal Internet membership editing screens.

Insurer applies adjustment to original bill and submits a reformatted summary sheet to company over Internet.

Company views resubmitted invoice with adjustment and reformatted summary sheet.

Company pays resubmitted invoice amount over Internet.

Company payment made using payment processor interface from which a selected account is paid from and all adjustments are applied; payment made using credit card, debit card, or check.

Insurer receives payment made by Company including confirmation no. and applied adjustments.

Insurer integrates/reconciles payment and adjustments to account receivable record.

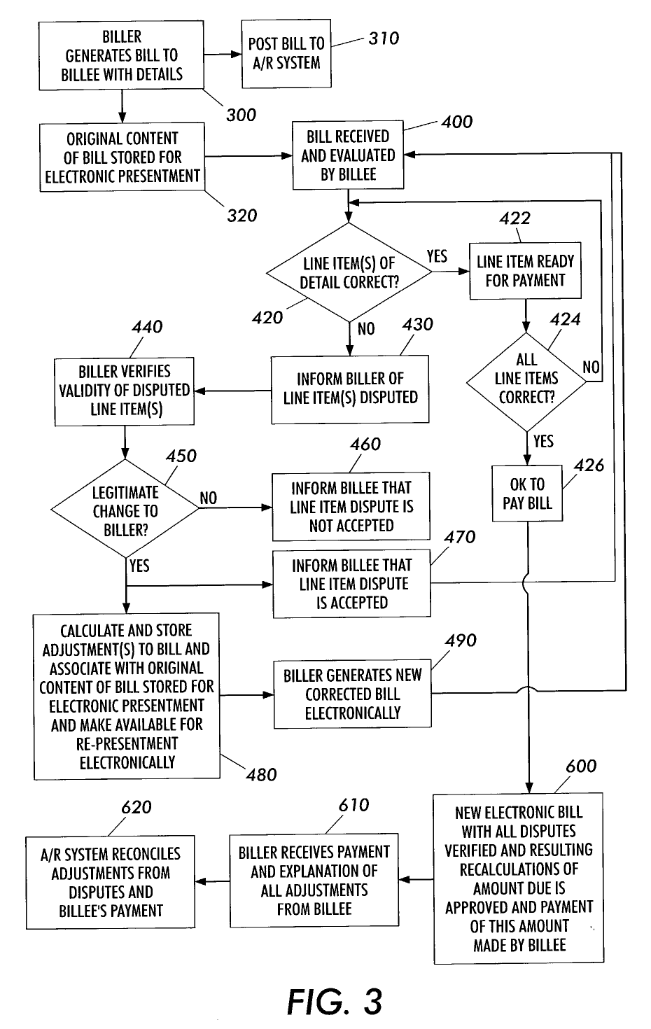

Referring to FIG. 3, the operation of the system 10 for electronic billing presentment and reconciliation in accordance with one or more embodiments will now be described.

At step 300, the contents of the electronic bill including individual line items are defined and generated and entered into billing server 16 by an operator at one of the personal computers 12(1)-12(n). The bill is entered into one or more fields provided in one or more documents or web pages and are stored in memory. The operator may access one or more Web pages sent from billing server 16 through networks 14 and displayed on display devices 13(1)-13(n) of personal computers 12(1)12(n). Billing server 16 will provide personal computers 12(1)-12(n) with as many Web pages and input fields appropriate for the particular bill as needed and described further herein. Billing server 16 may be programmed to be able to generate appropriate Web pages for the particular task. Billing server 16 may include programming in a number of languages and implementations for generating the Web pages as needed to implement the present invention as described herein, such as Java, Javascript, Visual Basic, Perl, CGI scripts, HTML, SGML or XML.

At step 310, the electronic bill is posted to the accounts receivable department or system.

At step 320, the bill from step 300 is stored in memory for electronic presentment and sent to the billee.

At step 400, the billee receives the electronic bill and evaluates the bill from the billee. The user at personal computer 12(1) reviews the document on the monitor 13(1) or generates a document using a word processing program such as Microsoft Word®, for example. Alternatively, the user at personal computer 12(1) may already have the generated document, either having received it attached to an e-mail message or having previously stored it in a memory storage associated with the personal computer 12(1). The user at personal computer 12(1) may generate documents to be printed out using a network printer.

Next at step 420, the user is presented with an option to contest each one of the one or more individual line items of the electronic bill. If the user believes that the one or more line items of the bill are not correct, then the NO branch is followed to Step 430. At step 420, the user has an opportunity to decide whether to contest the one or more individual line items or all of the individual line items. For example, each line item may have a selection box for the user to select including one or more predefined reasons for the contestment of the each line items. Additionally, a field on the screen may be presented for the user to populate with additional information or reasons for the contestment that may not be easily selected or described elsewhere.

At step 430, the billee sends the selected contestments, proposed adjustments, or provided information to the biller.

At step 440, the biller receives the disputed line items and proposed adjustments, provided information, and explanations and verifies validity of these disputed line items in combination with the information provided by the billee.

At step 450, the biller is presented with an option to decide whether each disputed line item and proposed adjustments is a legitimate request. If the biller determines the disputed line item(s) are not legitimate disputes, then the NO branch is followed and, at step 460, the biller informs the billee that the proposed adjustment(s) to the disputed line items is not accepted. If the biller determines that the disputed line item(s) are legitimately disputed, then the YES branch is followed, and at step 470, the biller informs the billee that the proposed adjustment(s) to the disputed line item(s) are accepted. The biller may accept some line items and reject other line items.

Next, at step 480, once the disputed line items have been reviewed and reported as accepted or rejected (steps 460, 470), the biller calculates and stores the adjustments to the bill, if any, and associates this information with the original content of the original bill. A new bill including this accepted or rejected line item information is made available for electronic presentment to the billee. The new bill may include a field indicating that the bill has been reviewed by the biller and a field with a summary of the accepted or rejected proposed line item adjustments or disputed line items and reasons for acceptance or rejection.

At step 490, the biller sends to the billee a new corrected bill; or the biller may also retrieve the new corrected bill. Once the billee receives the new corrected bill, step 420 may be repeated and the user is presented once again with an option to contest each one of the one or more individual line items of the electronic bill and to follow the bill review, adjustment and reconciliation process through step 620 as necessary and appropriate. Otherwise, the billee may proceed to step 600. The biller may allow unlimited number of reviews of the bill or specify a selected number of allowed reviews. The biller may set a time limit for a review to be made by the biller.

Referring back to Step 420, if the user believes that all of the line item(s) are correct, then the YES branch is followed to step 422 where an indication or selection that the line items are ready for payment and confirmation that all line items are ready for payment. At step 424, the user is presented with an option to confirm that all line items are correct. If it is OK to pay the bill, the user at step 426 indicates that it is ok to pay the bill.

Thereafter, at step 600, the new electronic bill with all disputes verified and resulting recalculation of amounts due is approved and payment of this amount made is made by the billee or the original electronic bill, if no adjustments were requested, is approved and payment of this amount made is made electronically by the billee.

At step 610, the biller receives the payment along with any explanations and adjustments, if any.

At step 620, the Accounts Receivables department or system, automatically reconciles the adjustments, if any, and posts the payment received by the biller.

In embodiments, the process may further include: after communicating electronically the second bill, receiving payment of the second bill; and integrating the adjustment of the at least one line item and payment in the account record; receiving an indication of a reason for the billing proposed change to the bill; communicating a revised bill including reference to a received communication; receiving a communication from a company that a payment has been made and associating the payment with an account receivable record. In embodiments, the payment may be made electronically; the electronic reconciliation may be automatic; communication may be over the Internet, network, or a wireless systems. The electronic reconciliation or integration in the billing process may include association of the at least one discrepancy in the insurance bill, the proposed modification, and the acceptance of the modified bill. In embodiments, third-party billing may be involved, however unless authorized, a third-party biller may not be prepared to make a judgment to correct the dispute.

In embodiments, the computer readable medium may function such that: the at least one line item of the first bill may be electronically identifiable as being disputed and at least one proposed change to the first bill may be electronically communicated to the biller; the at least one proposed change to the first bill may be electronically reviewed and accepted or denied by the biller and the acceptance or denial may then be electronically communicated to the billee; and the biller may receive payment in a second amount different than the first amount in the first bill along with electronic information sufficient to account for the difference between the first amount in the first bill and the second amount received by the biller. The computer readable medium may include an electronic tracking function which includes electronic storage of the at least one proposed adjustment and any acceptance of the at least one proposed adjustment at an accounting system associated with the account receivables record. The computer readable medium may update of the account receivables record automatically.

Other modifications may occur to those skilled in the art subsequent to a review of the present application, and these modifications, including equivalents thereof, are intended to be included within the scope of the present invention. Moreover, it is evident that many alternatives and variations thereof will be apparent to those skilled in the art. Accordingly, it is intended to embrace all such alternatives, modifications, and variations and their equivalents.

What is claimed is:

1. A billing process comprising:
generating an electronic first bill, the electronic first bill including at least one line item;
communicating electronically the first bill;
receiving electronically an indication of a billing discrepancy including a request for reconsideration of the at least one line item of the first bill;
reconsidering the at least one line item of the first bill;
communicating electronically the request for reconsideration of the at least one line item of the first bill is at least one of accepted or denied;
generating an electronic second bill including an adjustment of the at least one line item;
communicating electronically the second bill; and
integrating the adjustment of the at least one line item into an account record.

2. The billing process of claim 1 further comprising after communicating electronically the second bill, receiving payment of the second bill; and integrating the adjustment of the at least one line item and payment in the account record.

3. The billing process of claim 2 wherein the payment is made electronically.

4. A billing system comprising:
a computer network; and
computer readable medium associated with the computer network, the computer readable medium containing instructions for:
(1) generation of a first bill having at least one line item totaling a first amount;
(2) electronic storage of the first bill;
(3) electronic communication of the first bill from a biller to a billee and to an account receivable record;
(4) interactive electronic communication between the billee and the biller relating to a discrepancy in the first bill; and
(5) electronic reconciliation in the accounts receivable record of a difference between the first amount of the first bill and a second amount of a second bill electronically sent by the biller to the billee.

5. The billing system of claim 4 wherein the computer readable medium is adapted to function such that the at least one line item of the first bill may be electronically identifiable as being disputed and at least one proposed change to the first bill to be electronically communicated to the biller.

6. The billing system of claim 5 wherein the computer readable medium is adapted to function such that the at least one proposed change to the first bill may be electronically reviewed and accepted or denied by the biller and the acceptance or denial then electronically communicated to the billee.

7. The billing system of claim 6 wherein the computer readable medium is adapted to function such that the biller receives payment in a second amount different than the first amount in the first bill along with electronic information sufficient to account for the difference between the first amount in the first bill and the second amount received by the biller.

8. The billing system of claim 7 wherein the payment is electronic.

9. The billing system of claim 4 wherein the electronic reconciliation is automatic.

10. An insurance billing process comprising:
communicating electronically an insurance bill;
receiving an electronic communication of at least one discrepancy in the insurance bill;
communicating electronically a proposed modification to the insurance bill corresponding to the at least one discrepancy in the insurance bill;
receiving electronic acceptance of the proposed modification; and
electronic reconciliation in an accounts receivable record.

11. The insurance billing process of claim 10 wherein the communication is over the Internet.

12. The insurance billing process of claim 10 wherein the electronic reconciliation includes association of the at least one discrepancy in the insurance bill, the proposed modification, and the acceptance of the modified bill.

13. The insurance billing process of claim 10 further comprising receiving payment of the modified bill.

14. The insurance billing process of claim 10 wherein the electronic reconciliation is automatic.

15. The insurance billing process of claim 10 wherein the electronic communication further includes proposed changes to the insurance bill.

16. The insurance billing process of claim 10 further comprising receiving an indication of a reason for the billing proposed change to the insurance bill.

17. The insurance billing process of claim 10 further comprising communicating a revised insurance bill including reference to a received communication.

18. The insurance billing process of claim 10 further comprising receiving a communication from the company that the payment has been made and associating the payment with the account receivable record.

19. The insurance billing process of claim 10 further comprising a time limitation for receiving an electronic communication of at least one discrepancy in the insurance bill.

20. The insurance billing process of claim 10 further comprising a frequency limitation for number of times for receiving an electronic communication of at least one discrepancy in the insurance bill.

21. A process of billing comprising:
generating a first bill including at least one line item;
storing the first bill in memory suitable for electronic presentment;
communicating electronically the first bill;
receiving electronically an indication of a billing discrepancy including a request for reconsideration of the at least one line item of the first bill;
reconsidering the at least one line item of the first bill which was requested to be reconsidered as part of the indication of a billing discrepancy;
communicating electronically that the request for reconsideration of the at least one line item of the first bill is at least one of accepted or denied;
calculating at least one adjustment for each line item accepted in the request for reconsideration;
associating the at least one adjustment of the each line item accepted in reconsideration with the first bill in memory;
generating a second bill including the at least one adjustment of the at least one line item;
communicating electronically the second bill;
receiving payment of the second bill associated with the at least one adjustments; and
reconciling the at least one adjustment and payment in account receivable record.

22. The process of billing of claim 21 wherein the method is used in an industry including at least one of aerospace, automotive, petroleum & chemical, communications, consumer products, pharmaceutical, technology, transportation, utilities, public sector, government, healthcare, insurance, graphic arts, education, life sciences, financial services, legal, retail, manufacturing, and industrial.

23. A computer system for interactive resolution of a line item of an electronic bill between a biller and a billee comprising:
a computer network; and
computer readable medium associated with the computer network, the computer readable medium containing instructions for:
at least one electronic communication between a biller and a billee including at least one proposed adjustment to a line item of an electronic bill; and
electronic tracking of the at least one proposed adjustment and the at least one electronic communication sufficient for an update of an account receivables record.

24. The computer system of claim 23 wherein the electronic tracking includes electronic storage of the at least one proposed adjustment and any acceptance of the at least one proposed adjustment at an accounting system associated with the account receivables record.

25. The computer system of claim 24 wherein the update of the account receivables record is automatic.
